(19) United States
(12) Patent Application Publication
(10) Pub. No.: US 2026/0163872 A1
(43) Pub. Date: Jun. 11, 2026

(54) OPTIMIZED DATA ENCRYPTION AND DECRYPTION IN ETHERNET RING TOPOLOGIES

(71) Applicant: Cisco Technology, Inc., San Jose, CA (US)

(72) Inventors: Srinivasa Rao Nalluri, Bangalore (IN); Robert Edgar Barton, Richmond (CA); Saravanan M Karunanidhi, Bangalore (IN)

(21) Appl. No.: 18/940,721

(22) Filed: Nov. 7, 2024

(51) Int. Cl. H04L 9/40

(52) U.S. Cl. CPC H04L 63/065

(57) ABSTRACT

The present technology provides a group encryption key for a ring as a whole within a ring-based topology. The key can, for example, be managed by a central Key Server (KS) that then transmits the key and a group encryption tag to nodes on the ring. For example, the ring edge node can encode a tag into a header of a frame so that the tag functions as a group-based tag. Future nodes on the ring network can then avoid the burdensome decryption and encryption steps of the prior art peer-to-peer encryption and decryption process.

### TECHNICAL FIELD

The present disclosure relates to encryption within a network.

### BACKGROUND

Ethernet ring topologies are a common infrastructure for industrial internet-of-things (IoT) applications. These topologies provide for a “circle” of switches where Ethernet frames pass from one node to another. Current encryption methods require each frame to be encrypted in a peer-to-peer methodology, meaning the frames are encrypted and decrypted each time they are transmitted to another node. Large rings of up to 128 nodes are not uncommon, meaning a frame will be encrypted and decrypted at least 128 times when passing through the ring. This poses several problems. First, encryption protocols must be configured independently on each node of the ring. Second, it requires the frame to be encrypted and decrypted at each node of the ring which can require significant computational expense.

### BRIEF DESCRIPTION OF THE DRAWINGS

FIG. 1 is a diagram depicting a ring topology, according to an example embodiment.

FIG. 2A is a diagram depicting a ring topology with a first switch and a second switch, according to an example embodiment.

FIG. 2B is a diagram depicting a ring topology with a first switch and a second switch and with the flow of the frame shown, according to an example embodiment.

FIG. 2C is a diagram depicting a ring topology with a first switch and a second switch with additional flow of the frame shown, according to an example embodiment.

FIG. 3 is a diagram depicting a frame transmitted through an Ethernet ring topology, according to an example embodiment.

FIG. 4 illustrates a method of encrypting frames, according to an example embodiment.

FIG. 5 is a diagram depicting a computing system for implementing certain aspects of the present technology, according to an example embodiment.

### DETAILED DESCRIPTION

### Overview

The present technology overcomes the above problems by utilizing a group encryption key tag within the headers of frames passing through the ring network. Specifically, the technology establishes a group encryption key among a group of nodes in a ring network. The technology then encodes a Ring Encryption Tag (RET) in a header of a frame. The RET indicates to nodes within the ring network that the frame is part of an encryption group and that the frame does not need to be decrypted until the frame is transmitted out of the ring network. The technology then encrypts a payload of the frame using the group encryption key and transmits the frame through the ring network. This process is advantageous because later nodes do not need to perform the peer-to-peer encryption of the prior art due to the RET indicating that encryption has already been performed.

### Example Embodiments

An Ethernet ring topology is a network configuration where nodes (such as switches or routers) are connected in a circular arrangement, forming a closed loop. In this topology, each node is connected to two other nodes, one on each side, creating a continuous pathway for data transmission. Data frames travel around the ring, typically in one direction (unidirectional) or both directions (bidirectional) to reach their destination. This topology is particularly resilient, as it can maintain network integrity even if one connection is disrupted, by rerouting data in the opposite direction. The Ethernet ring topology is commonly used in metropolitan area networks (MANs) and other large-scale network environments where fault tolerance and high availability are critical.

Encryption of Ethernet frames in a ring topology is typically performed on a peer-to-peer basis, meaning a frame must be encrypted and decrypted for each transmission. The present technology improves upon this by providing a group encryption key for the ring as a whole. The key can, for example, be managed by a central Key Server (KS) for all nodes on the ring, avoiding the need for peer-to-peer encryption and decryption. The KS can be one of the participating nodes in the ring, such as the ring edge node. The KS can encode a tag into the header of the frame so that the tag functions as a group-based tag and a group key. The KS can do this itself or it can distribute the group-based tag to switches on the ring. As one example, the tag can be an EtherType that allows other nodes along the ring to correctly interpret that the frame is part of an encryption group, and will forward the frame on to the next hop without requiring the burdensome peer-to-peer encryption and decryption of the prior art.

The key can also be applied in a virtual local area network (VLAN). The key server can issue keys to each switch that in turn use the proper key for the VLAN, thereby allowing encryption privacy on a VLAN level. The entire ring can be a single VLAN or can be broken down into separate VLANs.

As frames enter the ring from one of the non-ring ports, the frame can be encrypted using and the group encryption tag can be encoded into the header of the frame to denote that the frame is encrypted. The frame can then stay encrypted along the entire path through the ring, and decrypted when the frame needs to exit the ring towards its destination. In doing so, the intermediate nodes on the ring do need not to encrypt and decrypt the frame each time it is transmitted, saving computational overhead and operating more efficiently as compared to the peer-to-peer encryption technique of the prior art.

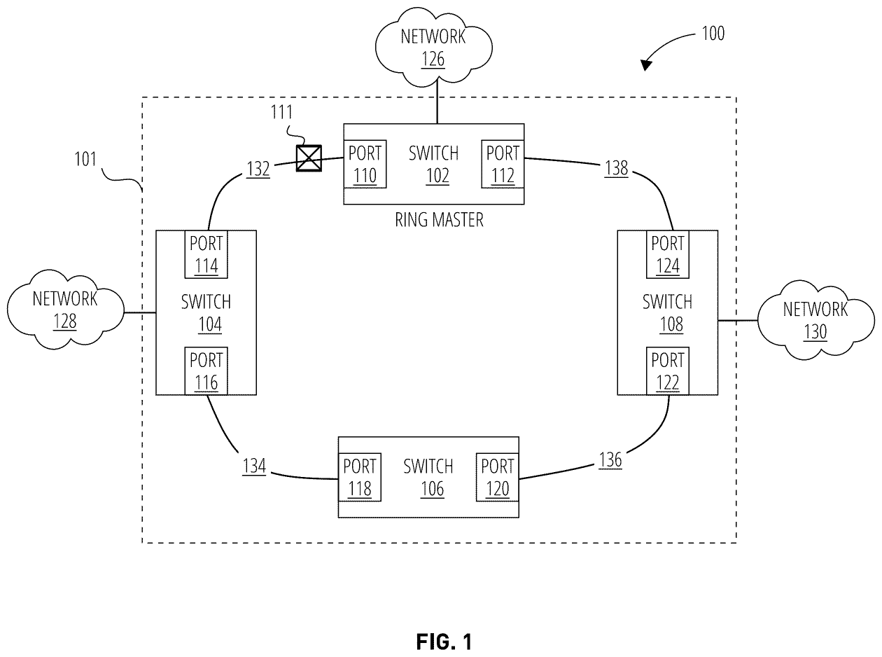

FIG. 1 is a block diagram of an exemplary network 100 in accordance with embodiments of the invention. The network 100 can be utilized in combination with one or more methods in accordance with embodiments of the invention, described herein, thereby enabling a quicker Layer 2 Ethernet convergence after a topology change within ring network 101. The network 100 can include an exemplary Ethernet ring topology, referred to herein as a ring network 101.

The ring network 101 can include a switch 102, switch 104, switch 106, and switch 108 that are communicably coupled in a ring configuration. Specifically, communication port 112 of switch 102 can be coupled to a communication port 124 of switch 108 via link 138. The communication port 122 of switch 108 can be coupled to a communication port 120 of switch 106 via link 136. Additionally, the communication port 118 of switch 106 can be coupled to a communication port 116 of switch 104 via link 134. The communication port 114 of switch 104 can be coupled to communication port 110 of switch 102 via link 132.

FIG. 1 further includes a network 126, network 128, and network 130, that can be coupled to the ring network 101. Specifically, network 126 can be coupled to switch 102, network 128 can be coupled to switch 104, and network 130 can be coupled to switch 108. In this configuration, electronic devices or components of communication networks can each intercommunicate via the ring network 101.

Within the ring network 101, one switch (e.g., switch 102) can be elected or configured to be the ring master at the ring initialization. This ring master election or configuration can be implemented in a variety of different ways. For example, the election window can be a configurable value, for example 10 seconds, but is not limited to such. As part of the election process, an election message can be sent across the ring network 101 in which each of the switch 102, the switch 104, the switch 106, and the switch 108 records its MAC ID (Media Access Control identification). It is noted that this election process can be part of the ring topology discovery mechanism. Once the ring master (e.g., the switch 102) has been elected or configured, the ring master marks one of its ring ports (e.g., communication port 110) in the ring network 101 as logically blocked, as shown by the X 111 in FIG. 1. Conversely, all of the other switches (i.e., switch 104, switch 106, and switch 108) have both of their respective ring ports in a forwarding mode or state. This configuration can ensure that there is no logical loop in the ring network 101 and that connectivity is maintained between any two ring switches. Note that within FIG. 1, each of switch 102, switch 104, switch 106, and switch 108 can include two ring ports where a MAC address learning process can take place.

Within FIG. 1, it is appreciated that the ring network 101 can include a greater or fewer number of communication switches than the switch 102, switch 104, switch 106, and switch 108 shown. The ring ports can also be implemented as trunk ports and can also be Etherchannel trunks. It is understood that network 128 and network 130 can each be implemented as a VLAN. Network 100 can include a greater or fewer number of communication networks than network 128 and network 130 shown. For example, switch 106 can be coupled to a communication network.

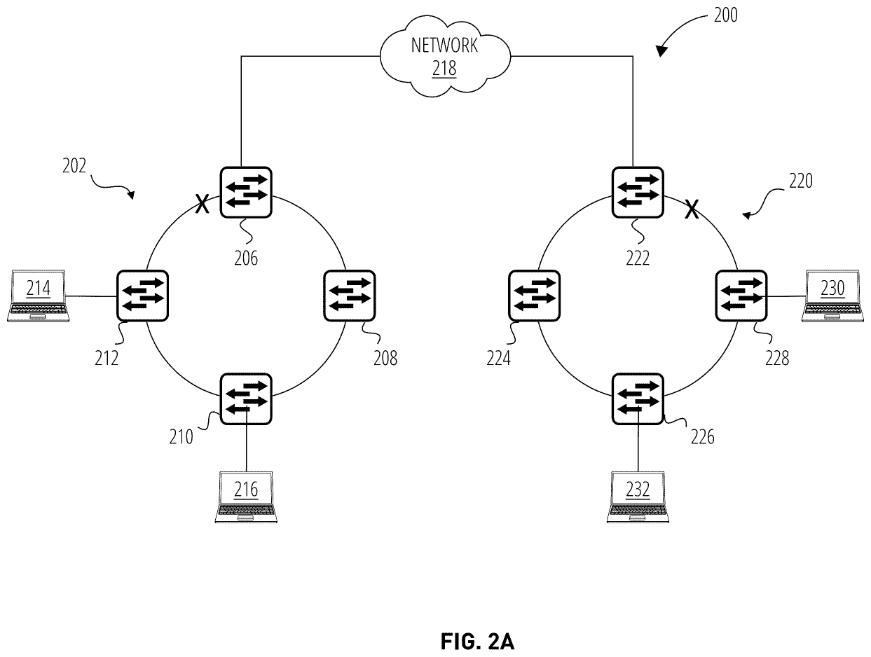

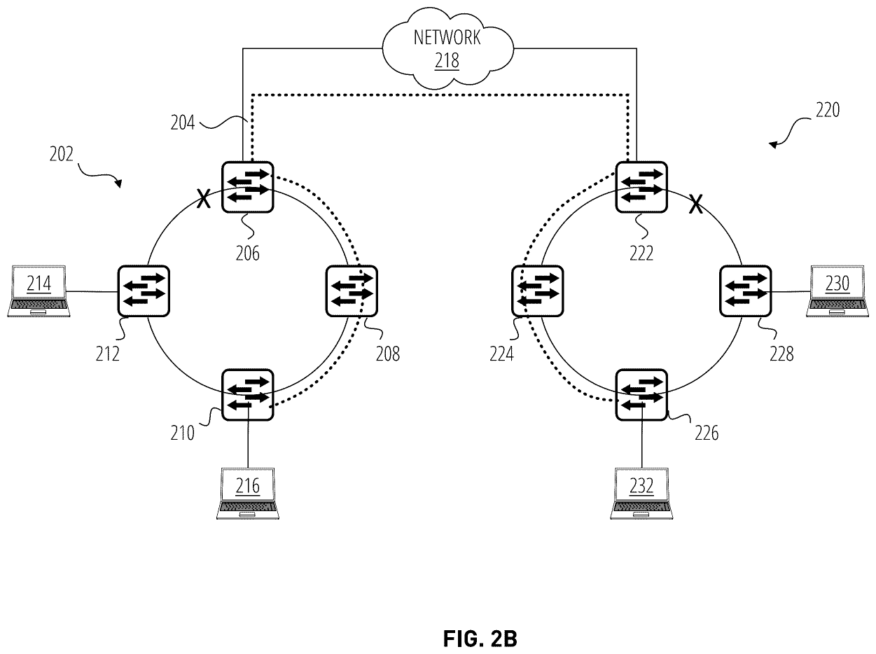

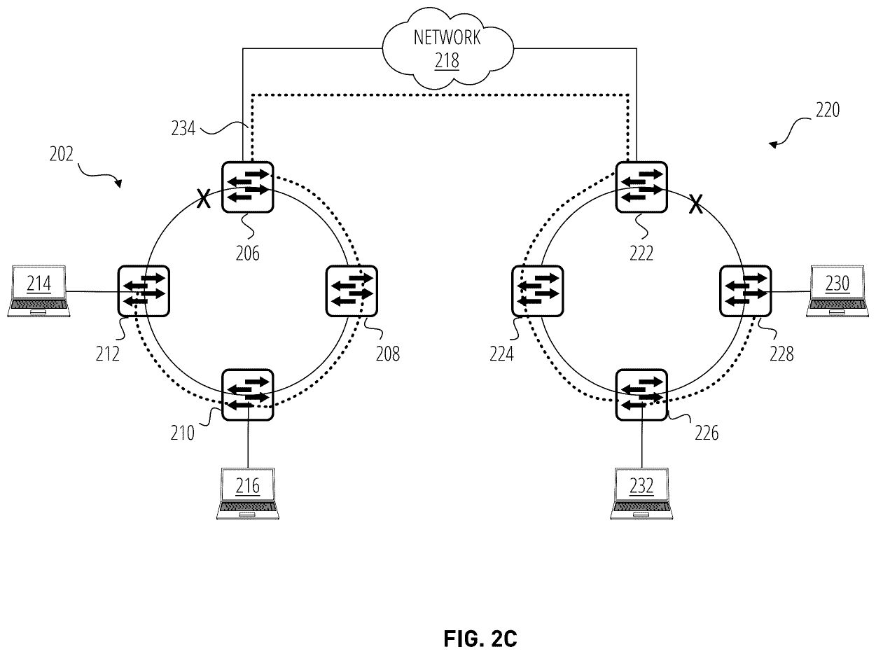

FIG. 2A illustrates an example of a system including ring Ethernet networks (e.g., ring network 202 and ring network 220) and network 218. Ring network 202 includes switch 206, switch 208, switch 210, and switch 212, for example. Switch 210 can be connected to switch 216, and switch 212 can be connected to switch 214. Similarly, ring network 220 can include switch 222, switch 224, switch 226, and switch 228. Switch 226 can be connected to switch 232, and switch 228 can be connected to switch 230. Ring network 202 can be connected to ring network 220 via network 218. As a non-limiting example, network 218 can be a Layer 3 network.

In system 200, excluding any Layer 3 security mechanisms, a conventional Ethernet frame from switch 214 to switch 230 would undergo six encryption and decryption cycles before reaching the other switch. That is, each transmission of the frame from one switch to the next would require a separate step of encrypting and decrypting. This is because encryption through ring networks is normally performed in a peer-to-peer fashion. In a ring network where a peer can be trusted and data protection is a key requirement, a method that reduces the number of encryptions and decryptions based on packet entry and exit points, along with a per-VLAN ring-level group key, will greatly improve the function of the ring.

This improvement can occur with a ring encryption tag (RET). A RET can be, in some embodiments, a tag placed in a header of a frame that communicates to nodes within the ring network that the frame is part of an encryption group and that the frame does not need to be decrypted until the frame is transmitted out of the ring network. This tag therefore allows the frame to be encrypted only once (e.g., at the entry boundary node, that is, a first point of entry for the frame as it enters the ring network illustrated as the system 200 in FIG. 2A) and decrypted only once (immediately before the frame exits the system 200/ring network). The RET can be managed by a key server and can be encoded into the header by the boundary node, in some embodiments.

FIG. 2B illustrates flow 204 of the frame through system 200 using a RET methodology. As shown, the frame is transmitted from switch 210 to switch 208 and then to switch 206. Thereafter, the frame is transmitted from ring network 202 to ring network 220 via network 218 which can be, For example, a Layer 3 network. The frame reaches ring network 220 with switch 222 being the entry boundary node. Switch 222 then transmits the frame to switch 224 and then switch 226 to then be accessed by switch 232.

In the above example, switch 210 can be considered the entry boundary node for ring network 202. Here, switch 210 can act as a boundary node and/or the KS and encode the frame with the RET in the header of the frame. In some embodiments, the KS can transmit the RET to the switches which then encode the RET into the header if that specific switch is the ingress boundary switch of the ring network.

When the frame then passes to ring network 220, switch 222 can receive the frame and inspect the header of the frame to determine whether the frame needs to be encrypted. The switch 222 would then determine the frame includes a RET and therefore has already been encrypted, therefore not requiring a decrypt/encrypt process as with prior art methods. Conversely, a switch that receives a frame that lacks a RET can determine the frame has not been encrypted, and can encrypt the frame while encoding the frame with a RET to specify that the frame has been encrypted.

FIG. 2C illustrates flow 234 through system 200. The flow 234 can act in much the same way as with FIG. 2B and with like elements being labeled with like numerals. Here, the frame is transmitted from switch 212 (accessible by switch 214) to switch 228 (accessible by switch 230). FIG. 2C is different than FIG. 2B at least because the frame travels across three switches within ring network 202 before being transmitted to ring network 220 via network 218. The RET methodology is therefore even more beneficial because it avoids additional encryption and decryption processes during the frame's transit from switch 212 to switch 228.

Note that in FIGS. 2A and 2B, the ring network 202 and ring network 220 include X marks to denote a temporary or permanent blockage of one of the ports. These X marks are located between switch 206 and switch 212 within ring network 202, and between switch 222 and switch 228 within ring network 220. The purpose of these temporary or permanent blockages is to allow the key exchange and encryption to take place. By blocking data traffic, this permits the control protocols to form the ring and for complete key exchange to occur. This also prevents a loop from forming and therefore causing data collision and duplication, network traffic overload, broadcast storms, and difficulty in troubleshooting.

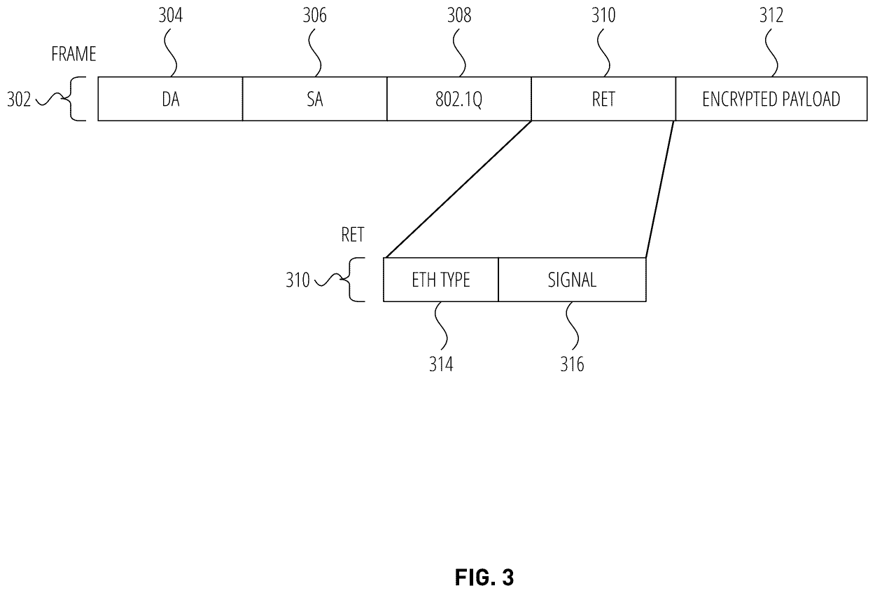

FIG. 3 illustrates a structure of a frame that includes a RET 310 in the header of the packet. The RET acts as a tag in the header for easy inspection and detection during frame processing so that switches can determine whether the frame needs to be encrypted when traveling through a ring network.

As shown, the frame 302 includes a destination address 304, a source address 306, an 802.1Q tag 308, a RET 310, and an encrypted payload 312. The RET 310 may include, for instance, an EtherType 314 or another signal component 316 that indicates to a switch that the frame belongs to an encryption group. For example, the signal component 316 could be a specific identifier or key that triggers the switch to process the frame according to the encryption protocol associated with the group.

Using the RET in the frame header, ring encryption flows can now be easily classified from non-encrypted flows or 802.1AE encrypted flows. As one example, the EtherType allows other nodes (e.g., the switches of FIGS. 2A-2C) along the ring to correctly interpret that the frame is part of an encryption group. This permits the nodes to forward the frame on to the next hop without requiring the burdensome peer-to-peer encryption and decryption of the prior art.

In an embodiment, group encryption key may be used on a per VLAN basis. For example, the entire ring network may be a VLAN or portions of the ring network may each be a separate VLAN. The KS can issue keys to each switch that in turn use the proper keys for each VLAN, allowing encryption privacy on a VLAN level. Here, the encryption and decryption flows can be VLAN based as well. In particular, based on the VLAN within which the packet arrived, the per VLAN key can be chosen by the KS. The KS can be, for example, the boundary node in the ring network. Encryption occurs when the frame enters the ring network at the first switch (e.g., the boundary node) and the node determines the frame is not already encrypted (i.e., that the frame does not include a RET in the header). The boundary node can then encrypt the payload of the frame and encode the RET in the header of the frame. Decryption happens when the frame egresses any non-ring port while it is encrypted (i.e., when the frame has RET in its header). There, the final egress boundary node can decrypt the frame before egressing it from the ring network.

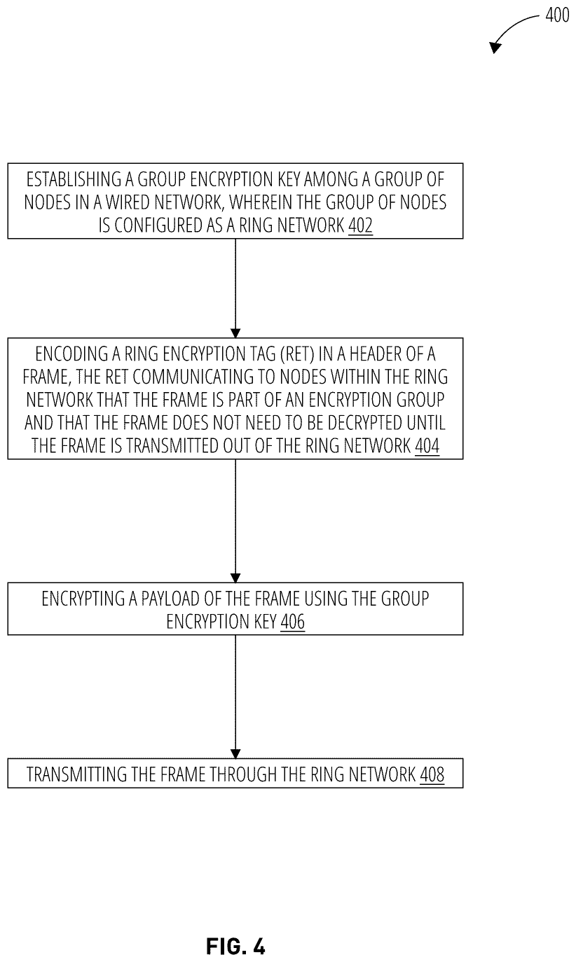

FIG. 4 illustrates an example method 400 for encrypting and tagging frames passing through a ring network. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some examples, the method 400 includes establishing a group encryption key among a group of nodes in a wired network, wherein the group of nodes is configured as a ring network at box 402. For example, a KS can establish a group encryption key among a group of nodes in a wired network. The nodes can be, for example, the switches described above with respect to FIGS. 2A-2C, and the ring network can be the ring networks discussed above with respect to FIGS. 2A-2C. The nodes of the ring network can include a boundary node, meaning a first point of entry for the frame as it enters the ring network. The boundary node can receive the RET from a KS and encode the RET into the header of the frame when the frame enters the ring network at the boundary node. The frame can therefore be encoded with a RET upon reaching the first node within the ring network. The frame can then travel to other nodes in the network without requiring a separate encryption and decryption each time.

According to some examples, the method 400 includes encoding a RET in a header of a frame, the RET communicating to nodes within the ring network that the frame is part of an encryption group and that the frame does not need to be decrypted until the frame is transmitted out of the ring network at block 404. For example, a switch from FIGS. 2A-2C can encode a RET in a header of a frame, the RET communicating to nodes within the ring network that the frame is part of an encryption group and that the frame does not need to be decrypted until the frame is transmitted out of the ring. For example, the RET can be or can include an EtherType. The EtherType can signal to other nodes that the frame is encrypted and should not be decrypted until it egresses the ring network. For example, the EtherType can be set to a specific value that is recognized by all nodes in the network, instructing them to forward the frame without decryption until it reaches its designated exit point from the ring, where decryption will be performed securely.

In some embodiments, the KS can issue keys to each switch that in turn uses the proper keys for each VLAN. That is, the ring network includes one or more VLANs, and the RET applies to at least one of the one or more VLANs. Here, the group encryption occurs on a VLAN-wide basis where either the entire ring network is one VLAN, or the ring network can be broken down into separate VLANs. In doing so, the method 400 ensures that encryption is applied uniformly across the designated VLAN(s), enhancing security by isolating encrypted traffic within specific VLANs. This approach not only simplifies key management but also minimizes the risk of unauthorized access, as only nodes within the same VLAN have the necessary keys to decrypt the data. Additionally, by segmenting the network into multiple VLANs, it allows for more granular control over network traffic and security policies, ensuring that sensitive data remains protected even in complex network environments.

According to some examples, the method 400 includes encrypting a payload of the frame using the group encryption key at block 406. For example, one of the switches from FIGS. 2A-2C can encrypt a payload of the frame using the group encryption key at block 406. The payload of the frame can be encrypted at a Layer 2 level. For example, this encryption can be achieved using protocols like MACsec (Media Access Control Security), which secures data between two directly connected nodes, ensuring that the payload remains confidential and tamper-proof as it traverses the network. This type of encryption provides an additional layer of security by protecting the data even before it reaches higher layers of the network stack.

According to some examples, the method 400 includes transmitting the frame through the ring network at block 408. For example, one of the switches from FIGS. 2A-2C can transmit the frame through the ring network at block 408. Either temporarily or permanently, the method 400 can block a port of one of the nodes to prevent a loop within the ring network in which the frame travels entirely around the ring network. In some embodiments, the frame can include a destination address header specifying a destination that is a plurality of nodes away. For example, one of the switches from FIGS. 2A-2C can encode a destination address in the header of the frame, the destination address requiring transmission of the frame past a plurality of the nodes in the ring network.

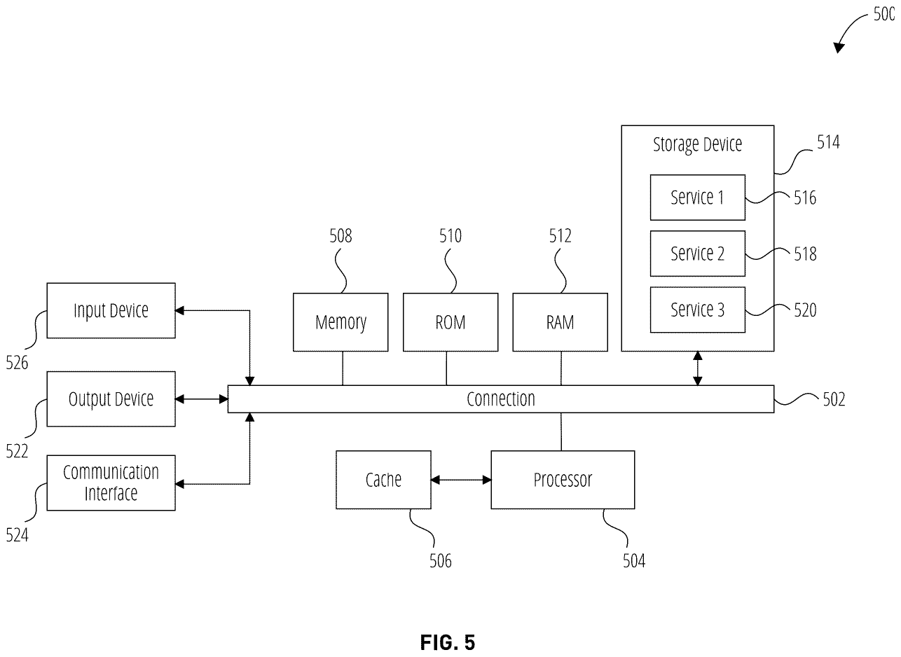

FIG. 5 shows an example of computing system 500, which can be for example any computing device making up the switches or nodes discussed above, or any component thereof in which the components of the system are in communication with each other using connection 502. Connection 502 can be a physical connection via a bus, or a direct connection into processor 504, such as in a chipset architecture. Connection 502 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 500 includes at least one processing unit (CPU or processor) 504 and connection 502 that couples various system components including system memory 508, such as read-only memory (ROM) 510 and random-access memory (RAM) 512 to processor 504. Computing system 500 can include a cache of high-speed memory 506 connected directly with, in close proximity to, or integrated as part of processor 504.

Processor 504 can include any general-purpose processor and a hardware service or software service, such as services 516, 518, and 520 stored in storage device 514, configured to control processor 504 as well as a special-purpose processor where software instructions are incorporated into the actual processor design. Processor 504 may essentially be a completely self-contained computing system, containing multiple cores or processors, a bus, memory controller, cache, etc. A multi-core processor may be symmetric or asymmetric.

To enable user interaction, computing system 500 includes an input device 526, which can represent any number of input mechanisms, such as a microphone for speech, a touch-sensitive screen for gesture or graphical input, keyboard, mouse, motion input, speech, etc. Computing system 500 can also include output device 522, which can be one or more of a number of output mechanisms known to those of skill in the art. In some instances, multimodal systems can enable a user to provide multiple types of input/output to communicate with computing system 500. Computing system 500 can include communication interface 524, which can generally govern and manage the user input and system output. There is no restriction on operating on any particular hardware arrangement, and therefore the basic features here may easily be substituted for improved hardware or firmware arrangements as they are developed.

Storage device 514 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 514 can include software services, servers, services, etc., that when the code that defines such software is executed by the processor 504, it causes the system to perform a function. In some embodiments, a hardware service that performs a particular function can include the software component stored in a computer-readable medium in connection with the necessary hardware components, such as processor 504, connection 502, output device 522, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### Aspects

Aspect 1. A method comprising establishing a group encryption key among a group of nodes in a wired network, wherein the group of nodes is configured as a ring network; encoding a Ring Encryption Tag (RET) in a header of a frame, the RET communicating to nodes within the ring network that the frame is part of an encryption group and that the frame does not need to be decrypted until the frame is transmitted out of the ring network; encrypting a payload of the frame using the group encryption key; and transmitting the frame through the ring network.

Aspect 2. The method of Aspect 1, wherein the nodes of the ring network include a boundary node, the boundary node being a first point of entry for the frame as it enters the ring network, and wherein the boundary node encodes the RET.

Aspect 3. The method of Aspect 1, wherein the RET includes an EtherType.

Aspect 4. The method of Aspect 1, wherein the ring network includes one or more virtual local area networks (one or more VLANs), and wherein the RET applies to at least one of the one or more VLANs.

Aspect 5. The method of Aspect 1, further comprising blocking a port of one of the nodes to prevent a loop within the ring network in which the frame travels entirely around the ring network.

Aspect 6. The method of Aspect 1, wherein the payload of the frame is encrypted at a Layer 2 level.

Aspect 7. The method of Aspect 1, further comprising encoding a destination address in the header of the frame, the destination address requiring transmission of the frame past a plurality of the nodes in the ring network.

Aspect 8. A network device comprising a storage configured to store instructions; and at least one processor configured to execute the instructions and cause the at least one processor to: establish a group encryption key among a group of nodes in a wired network, wherein the group of nodes is configured as a ring network; encode a RET in a header of a frame, the RET communicating to nodes within the ring network that the frame is part of an encryption group and that the frame does not need to be decrypted until the frame is transmitted out of the ring network; encrypt a payload of the frame using the group encryption key; and transmit the frame through the ring network.

Aspect 9. The network device of Aspect 8, wherein the nodes of the ring network include a boundary node, the boundary node being a first point of entry for the frame as it enters the ring network, and wherein the boundary node encodes the RET.

Aspect 10. The network device of Aspect 8, wherein the RET includes an EtherType.

Aspect 11. The network device of Aspect 8, wherein the ring network includes one or more VLANs, and wherein the RET applies to at least one of the one or more VLANs.

Aspect 12. The network device of Aspect 8, wherein the at least one processor is configured to execute the instructions and further cause the at least one processor to block a port of one of the nodes to prevent a loop within the ring network in which the frame travels entirely around the ring network.

Aspect 13. The network device of Aspect 8, wherein the payload of the frame is encrypted at a Layer 2 level.

Aspect 14. The network device of Aspect 8, wherein the at least one processor is configured to execute the instructions and further cause the at least one processor to encode a destination address in the header of the frame, the destination address requiring transmission of the frame past a plurality of the nodes in the ring network.

Aspect 15. A non-transitory computer-readable storage medium including instructions that, when executed by at least one processor, cause the at least one processor to establish a group encryption key among a group of nodes in a wired network, wherein the group of nodes is configured as a ring network; encode a RET in a header of a frame, the RET communicating to nodes within the ring network that the frame is part of an encryption group and that the frame does not need to be decrypted until the frame is transmitted out of the ring network; encrypt a payload of the frame using the group encryption key; and transmit the frame through the ring network.

Aspect 16. The non-transitory computer-readable storage medium of Aspect 15, wherein the nodes of the ring network include a boundary node, the boundary node being a first point of entry for the frame as it enters the ring network, and wherein the boundary node encodes the RET.

Aspect 17. The non-transitory computer-readable storage medium of Aspect 15, wherein the RET includes an EtherType.

Aspect 18. The non-transitory computer-readable storage medium of Aspect 15, wherein the ring network includes one or more VLANs, and wherein the RET applies to at least one of the one or more VLANs.

Aspect 19. The non-transitory computer-readable storage medium of Aspect 15, wherein the at least one processor is configured to execute the instructions and further cause the at least one processor to block a port of one of the nodes to prevent a loop within the ring network in which the frame travels entirely around the ring network.

Aspect 20. The non-transitory computer-readable storage medium of Aspect 15, wherein the payload of the frame is encrypted at a Layer 2 level.

### VARIATIONS AND IMPLEMENTATIONS

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, For example, network appliances, forwarders, routers, servers, switches, gateways, bridges, load balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
establishing a group encryption key among a group of nodes in a wired network, wherein the group of nodes is configured as a ring network;
encoding a Ring Encryption Tag (RET) in a header of a frame, the RET communicating to nodes within the ring network that the frame is part of an encryption group and that the frame does not need to be decrypted until the frame is transmitted out of the ring network;
encrypting a payload of the frame using the group encryption key; and
transmitting the frame through the ring network.

2. The method of claim 1, wherein the nodes of the ring network include a boundary node, the boundary node being a first point of entry for the frame as it enters the ring network, and wherein the boundary node encodes the RET.

3. The method of claim 1, wherein the RET includes an EtherType.

4. The method of claim 1, wherein the ring network includes one or more virtual local area networks (one or more VLANs), and wherein the RET applies to at least one of the one or more VLANs.

5. The method of claim 1, further comprising blocking a port of one of the nodes to prevent a loop within the ring network in which the frame travels entirely around the ring network.

6. The method of claim 1, wherein the payload of the frame is encrypted at a Layer 2 level.

7. The method of claim 1, further comprising encoding a destination address in the header of the frame, the destination address requiring transmission of the frame past a plurality of the nodes in the ring network.

8. A network device comprising:
a storage configured to store instructions; and
at least one processor configured to execute the instructions and cause the at least one processor to:
establish a group encryption key among a group of nodes in a wired network, wherein the group of nodes is configured as a ring network;
encode a RET in a header of a frame, the RET communicating to nodes within the ring network that the frame is part of an encryption group and that the frame does not need to be decrypted until the frame is transmitted out of the ring network;
encrypt a payload of the frame using the group encryption key; and
transmit the frame through the ring network.

9. The network device of claim 8, wherein the nodes of the ring network include a boundary node, the boundary node being a first point of entry for the frame as it enters the ring network, and wherein the boundary node encodes the RET.

10. The network device of claim 8, wherein the RET includes an EtherType.

11. The network device of claim 8, wherein the ring network includes one or more VLANs, and wherein the RET applies to at least one of the one or more VLANs.

12. The network device of claim 8, wherein the at least one processor is configured to execute the instructions and further cause the at least one processor to block a port of one of the nodes to prevent a loop within the ring network in which the frame travels entirely around the ring network.

13. The network device of claim 8, wherein the payload of the frame is encrypted at a Layer 2 level.

14. The network device of claim 8, wherein the at least one processor is configured to execute the instructions and further cause the at least one processor to encode a destination address in the header of the frame, the destination address requiring transmission of the frame past a plurality of the nodes in the ring network.

15. A non-transitory computer-readable storage medium including instructions that, when executed by at least one processor, cause the at least one processor to:
establish a group encryption key among a group of nodes in a wired network, wherein the group of nodes is configured as a ring network;
encode a RET in a header of a frame, the RET communicating to nodes within the ring network that the frame is part of an encryption group and that the frame does not need to be decrypted until the frame is transmitted out of the ring network;
encrypt a payload of the frame using the group encryption key; and
transmit the frame through the ring network.

16. The non-transitory computer-readable storage medium of claim 15, wherein the nodes of the ring network include a boundary node, the boundary node being a first point of entry for the frame as it enters the ring network, and wherein the boundary node encodes the RET.

17. The non-transitory computer-readable storage medium of claim 15, wherein the RET includes an EtherType.

18. The non-transitory computer-readable storage medium of claim 15, wherein the ring network includes one or more VLANs, and wherein the RET applies to at least one of the one or more VLANs.

19. The non-transitory computer-readable storage medium of claim 15, wherein the at least one processor is configured to execute the instructions and further cause the at least one processor to block a port of one of the nodes to prevent a loop within the ring network in which the frame travels entirely around the ring network.

20. The non-transitory computer-readable storage medium of claim 15, wherein the payload of the frame is encrypted at a Layer 2 level.
